(19) United States
(12) Patent Application Publication
(10) Pub. No.: US 2026/0184149 A1
(43) Pub. Date: Jul. 2, 2026

(54) TRUNK COVER AND PICKUP TRUCK

(71) Applicant: WINBO-DONGJIAN AUTOMOTIVE TECHNOLOGY CO., LTD., Foshan, Guangdong (CN)

(72) Inventor: Weiting He, Foshan, Guangdong (CN)

(21) Appl. No.: 18/861,887

(22) PCT Filed: Jul. 23, 2024
(86) PCT No.: PCT/CN2024/107072

§ 371 Date: Oct. 31, 2024

(30) Foreign Application Priority Data
Aug. 30, 2023 (CN) 202311104999.X
Oct. 23, 2023 (CN) 202322851208.1
Jun. 7, 2024 (CN) 202421313453.5

(51) Int. Cl. B60J 7/16; B60J 7/00

(52) U.S. Cl. CPC B60J 7/1607; B60J 7/0084

(57) ABSTRACT

Provided are a trunk cover and a pickup truck. The trunk cover includes a top cover and multiple side covers. An edge of a side surface of the top cover is provided with a first connecting plate. The multiple side covers are arranged around an edge of the top cover for a circumference, wherein each side cover is provided with a second connecting plate at an end close to the top cover, the second connecting plate is arranged parallel to the first connecting plate, the second connecting plate is detachably connected to the first connecting plate, the multiple side covers are all arranged obliquely relative to the top cover, and the top cover covers an end of the side cover near the top cover.

### CROSS-REFERENCE TO RELATED APPLICATION

The present disclosure claims the priority to the Chinese patent application with the filling No. 202311104999.X filed with the Chinese Patent Office on Aug. 30, 2023, and entitled “HIGH COVER FOR TRUNK AND PICKUP TRUCK THEREOF”, the contents of which are incorporated herein by reference in entirety;
the present disclosure claims the priority to the Chinese patent application with the filling No. 202322851208.1 filed with the Chinese Patent Office on Oct. 23, 2023, and entitled “HIGH COVER FOR TRUNK AND PICKUP TRUCK”, the contents of which are incorporated herein by reference in entirety; and
the present disclosure claims the priority to the Chinese patent application with the filling No. 202421313453.5 filed with the Chinese Patent Office on Jun. 7, 2024, and entitled “TRUNK COVER AND PICKUP TRUCK”, the contents of which are incorporated herein by reference in entirety.

### TECHNICAL FIELD

The present disclosure relates to the technical field of vehicle trunks, and particularly to a trunk cover and a pickup truck.

### BACKGROUND ART

A pickup truck is a vehicle that adopts a sedan-like front end and cab, along with an open freight container. Although the open freight container can accommodate a larger volume of goods and has a high carrying capacity, it is not theft-proof and cannot protect the freight inside the freight container during adverse weather conditions like rain or snow. Therefore, it is common practice to arrange a cover on the trunk of the pickup truck.

In the related art, a trunk cover of the pickup truck is typically assembled from a top cover with the left and right side covers, and front and rear side covers. However, due to limitations in assembly techniques, the current trunk covers of the pickup trucks still suffer from problems of water leakage and seepage.

### SUMMARY

The present disclosure provides a trunk cover, including:
a top cover, wherein an edge of a side surface of the top cover is provided with a first connecting plate; and
multiple side covers, arranged around an edge of the top cover for a circumference, wherein each side cover is provided with a second connecting plate at an end close to the top cover, the second connecting plate is arranged parallel to the first connecting plate, the second connecting plate is detachably connected to the first connecting plate, the multiple side covers are all arranged obliquely relative to the top cover, and the top cover covers an end of the side cover near the top cover.

Based on the above technical solution, the trunk cover provided by the present disclosure includes a top cover and multiple side covers. The side covers are all mounted on one side surface of the top cover, and the top cover is covered over the side covers and detachably connected through the first connecting plate to the second connecting plate on the side covers. Thus, the side covers can provide corresponding support for the top cover, thus enhancing the overall strength of the trunk cover. Additionally, the top cover can cover the splicing seam end between adjacent side covers to reduce the probability of rainwater entering the splicing seam, thereby decreasing the likelihood of water leakage and seepage and improving the waterproof performance of the trunk cover. Furthermore, the mounting method of covering the side covers with the top cover is less difficult, thus facilitating the operation of personnel. This makes the trunk cover provided by the present disclosure easier to produce.

In some possible embodiments, the multiple side covers include a first side cover, a second side cover, a third side cover, and a fourth side cover, the first side cover and the second side cover are one-to-one correspondingly connected to two opposite side edges of the top cover, and the third side cover and the fourth side cover are one-to-one correspondingly mounted on other two opposite side edges of the top cover.

In some possible embodiments, the trunk cover is configured with a first direction and a second direction that are perpendicular to each other;
in the first direction, a dimension of an end of the first side cover near the top cover and a dimension of an end of the second side cover near the top cover are both smaller than a dimension of the top cover; and
in the second direction, a dimension of an end of the third side cover near the top cover and a dimension of an end of the fourth side cover near the top cover are both smaller than a dimension of the top cover.

In some possible embodiments, an end of the first side cover near the third side cover and an end of the second side cover near the third side cover are each provided with a first mounting plate, the first mounting plate is arranged at an edge of the side cover where it itself is located and faces an interior of the trunk cover, and both the first side cover and the second side cover are detachably connected to the third side cover through the first mounting plate.

In some possible embodiments, both side edges of the third side cover are provided with second mounting plates, and the third side cover is detachably connected to the first mounting plate on the first side cover and the first mounting plate on the second side cover through the two second mounting plates in a one-to-one correspondence.

In some possible embodiments, the fourth side cover comprises an outer frame and an inner plate, the outer frame is in a Π shape, the outer frame is detachably mounted to the top cover through the second connecting plate, and the inner plate is hinged inside the outer frame.

In some possible embodiments, an end of the outer frame near the first side cover and an end of the outer frame near the second side cover are each provided with a third mounting plate, an end of the first side cover near the outer frame and an end of the second side cover near the outer frame are each provided with a fourth mounting plate, and both the first side cover and the second side cover are detachably connected to the third mounting plate of the fourth side cover via the fourth mounting plate.

In some possible embodiments, a waterproof glue is provided at the connection between the top cover and the side cover and at the connection between the side covers.

In some possible embodiments, the top cover includes at least two splicing plates, and the at least two splicing plates are sequentially connected.

In some possible embodiments, the top cover includes a first splicing plate and a second splicing plate that are connected; and
an end of the first splicing plate near the second splicing plate is provided with a water guide groove, the water guide groove is provided with an opening structure, and the second splicing plate covers the opening structure.

In some possible embodiments, the first splicing plate includes a first splicing plate main body and a bending portion, the bending portion is located at an end of the first splicing plate main body near the second splicing plate, and the water guide groove is formed by the bending portion.

In some possible embodiments, the bending portion includes a first bending plate, a second bending plate, and a third bending plate; the first bending plate is connected between the first splicing plate main body and the second bending plate; the third bending plate is opposite to the first bending plate; and the opening structure is opposite to the second bending plate; and
the first bending plate, the second bending plate, and the third bending plate cooperate to form the water guide groove.

In some possible embodiments, the bending portion includes a first bending plate connected to the first splicing plate main body;
the second splicing plate includes a second splicing plate main body and a transition plate, wherein the transition plate is located on a side of the second splicing plate main body near the first splicing plate; and
the transition plate is fitted against a side of the first bending plate near the second splicing plate and is connected to the first bending plate.

In some possible embodiments, the waterproof glue is provided between the transition plate and the first bending plate.

In some possible embodiments, the trunk cover is configured with a second direction, and the water guide groove is parallel to the second direction; and
along the second direction, at least one end of the water guide groove is configured with a water outlet that communicates with an external environment.

In some possible embodiments, along the second direction, each end of the water guide groove is configured with a water outlet; and
a side of the second splicing plate near the first splicing plate is configured with two avoidance notches, and each of the two water outlets correspondingly communicates with the external environment through each of the two avoidance notches.

In some possible embodiments, a position where the water outlet is located is further configured with a flow guide plate, and the flow guide plate is configured to direct water in the water guide groove toward the water outlet for collection.

In some possible embodiments, a side surface of the top cover facing the side cover is provided with multiple reinforcement ribs, the multiple reinforcement ribs are arranged in a grid-like distribution, and an end portion of each reinforcement rib is connected to the first connecting plate.

In the embodiment, the present disclosure also provides a pickup truck, which includes a cab, an open freight container, and the trunk cover provided in the above embodiments, wherein the trunk cover is mounted on the open freight container.

### BRIEF DESCRIPTION OF DRAWINGS

FIG. 1 illustrates a schematic diagram of a three-dimensional structure of a trunk cover in some embodiments;

FIG. 2 illustrates a schematic structural diagram of a top cover in some embodiments;

FIG. 3 illustrates a schematic structural diagram of a side cover in some embodiments;

FIG. 4 illustrates a partially enlarged schematic structural diagram of portion A in FIG. 3;

FIG. 5 illustrates a partially enlarged schematic structural diagram of portion B in FIG. 3;

FIG. 6 illustrates a schematic structural diagram of a trunk cover in some other embodiments;

FIG. 7 illustrates a partially enlarged schematic structural diagram of portion C in FIG. 6;

FIG. 8 illustrates a partially sectional schematic structural diagram of a top cover in some embodiments;

FIG. 9 illustrates a schematic structural diagram of a portion of a first splicing plate in some embodiments; and

FIG. 10 illustrates a schematic diagram of a three-dimensional structure of a top cover in some other embodiments.

### REFERENCE NUMERALS

1000—trunk cover;
100—top cover; 110—first splicing plate; 1101—water guide groove; 1102—opening structure; 1103—water outlet; 111—first splicing plate main body; 112—bending portion; 1121—first bending plate; 1122—second bending plate; 1123—third bending plate; 120—second splicing plate; 121—second splicing plate main body; 1211—avoidance notch; 122—transition plate; 130—flow guide plate; 140—first connecting plate; 150—reinforcement rib;
200—side cover; 210—first side cover; 220—second side cover; 230—third side cover; 240—fourth side cover; 241—outer frame; 242—inner plate; 243—handle; 250—first mounting plate; 260—second mounting plate; 270—third mounting plate; 280—fourth mounting plate; 290—second connecting plate;
300—waterproof glue;
M—first direction; N—second direction.

### DETAILED DESCRIPTION OF EMBODIMENTS

The following is a detailed description of the embodiments of the present disclosure, with examples shown in the drawings. Throughout the description, similar or identical reference numerals indicate corresponding or similar elements with the same or similar functions. The embodiments described below by reference to the drawings are exemplary and are intended only to explain the present disclosure and are not to be construed as a limitation of the present disclosure.

In the description of the present disclosure, it should be understood that the terms “length”, “width”, “thickness”, “up”, “down”, “front”, “back”, “left”, “right”, “top”, “bottom”, “inside”, “outside”, “circumferential” and other directional or positional relationships are based on the orientations or positional relationships shown in the drawings. They are solely to describe the present disclosure and simplify the description, rather than indicating or implying that the referenced devices or elements must have a specific orientation, or be constructed and operated in a specific orientation. Therefore, they should not be construed as limitations on the present disclosure.

Additionally, the terms “first” and “second” are used for descriptive objectives only and should not be understood as indicating or implying relative importance or specifying the quantity of the indicated technical features. Consequently, features labeled with “first” or “second” can explicitly or implicitly include one or more of those features. In the description of the present disclosure, the term “multiple” means two or more, unless otherwise explicitly specified.

In the present disclosure, unless otherwise clearly stipulated and limited, the terms “mount”, “link”, “connect”, and “fix” should be understood in a broad sense. For example, it can be a fixed connection, a detachable connection, or an integral connection; it can be a mechanical connection, an electrical connection, a direct connection, an indirect connection through an intermediary, an internal communication between two components, or the interaction relationship between two components. Those of ordinary skill in the art can understand the meanings of the above terms in the present disclosure according to specific situations.

In the present disclosure, unless otherwise expressly provided and limited, the first feature “on” or “under” the second feature may be a direct contact between the first and second features, or an indirect contact between the first and second features through an intermediate medium. Furthermore, the first feature being “above”, “over” and “on top of” the second feature can mean that the first feature is directly above or diagonally above the second feature, or simply that the first feature is horizontally higher than the second feature. The first feature is “under”, “below” and “beneath” the second feature, which can mean that the first feature is directly below or diagonally below the second feature, or it can simply mean that the horizontal height of the first feature is less than that of the second feature.

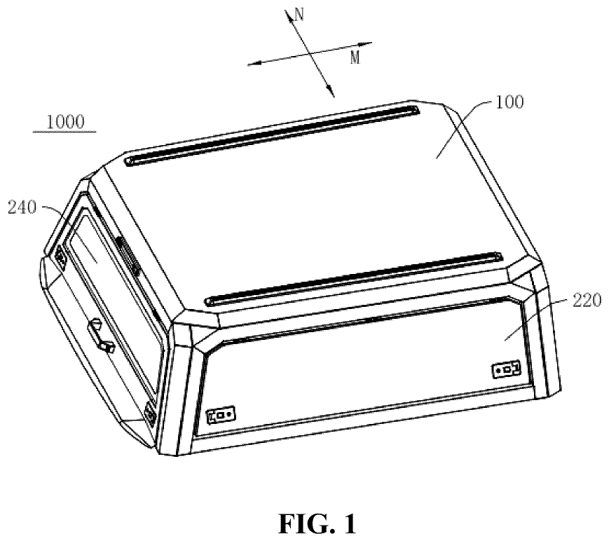

As shown in FIG. 1, an embodiment provides a trunk cover 1000, configured for use on a vehicle, such as a pickup truck, which can cover the freight container of the pickup truck.

As shown in FIGS. 1 to 3, the trunk cover 1000 includes a top cover 100 and multiple side covers 200. The top cover 100 is provided with a first connecting plate 140 on one side surface. The multiple side covers 200 are mounted on one side of the top cover 100 and are connected to an edge of the top cover 100. The multiple side covers 200 are arranged around the edge of the top cover 100. Moreover, each of the side covers 200 is inclined relative to the top cover 100. It can be understood that the top cover 100 and the multiple side covers 200 together form the trunk cover 1000.

Additionally, the top cover 100 covers the end of the side covers 200 near the top cover 100. Each side cover 200 is provided with a second connecting plate 290 at the edge near the top cover 100. The second connecting plate 290 is arranged parallel to the first connecting plate 140, and the second connecting plate 290 is detachably connected to the first connecting plate 140.

In some embodiments, a shape of the top cover 100 can generally be quadrilateral. The trunk cover 1000 can include four side covers 200, with each of the four side covers 200 correspondingly arranged at one of the four side edges of the top cover 100.

Of course, in other embodiments, it is not excluded that the shape of the top cover 100 can be configured to be a pentagon or a hexagon. The top cover 100 can correspondingly include five or six side edges. The number of side covers 200 can equal the number of side edges of the top cover 100.

In the embodiments, the top cover 100 is arranged to cover the end of the side cover 200 near the top cover 100, and the first connecting plate 140 is provided on the side surface of the top cover 100 facing the interior of the trunk cover 1000. Thus, the connection between the top cover 100 and the side cover 200 can be arranged beneath the top cover 100. In the event of rainy or snowy weather, rainwater can flow along the top cover 100, thus reducing the likelihood of rainwater flowing into the seam between the top cover 100 and the side cover 200. This, in turn, can reduce the possibility of water leakage and seepage from the trunk cover 1000 at the connection seams.

In related technologies, the top cover 100 and the side covers 200 are spliced together using step plates, where the side covers 200 do not provide any supporting effect for the top cover 100. The supporting force of the top cover 100 is entirely provided by bolts or screws at the splicing points.

However, in the trunk cover 1000 of the present disclosure, the top cover 100 covers the end of the side covers 200 near the top cover 100. This allows the side covers 200 to provide corresponding support for the top cover 100, thus making the support of the top cover 100 more reliable and increasing the load-bearing capacity of the top cover 100. Furthermore, by covering the top cover 100 over the end of the side covers 200 near the top cover 100, the mounting process is also simpler and more convenient, which improves the manufacturing workflow of the trunk cover 1000, reduces the mounting difficulty of the top cover 100, saves mounting time, and facilitates the production of the trunk cover 1000.

As shown in FIGS. 1 to 3, the multiple side covers 200 can include a first side cover 210, a second side cover 220, a third side cover 230, and a fourth side cover 240. The first side cover 210 and the second side cover 220 are arranged one-to-one correspondingly at two opposite side edges of the top cover 100, and the first side cover 210 and the second side cover 220 are arranged in a symmetrical manner. The third side cover 230 and the fourth side cover 240 are one-to-one correspondingly arranged at the other two opposite side edges of the top cover 100.

In the embodiment, the first side cover 210 and the second side cover 220 are arranged in a symmetrical manner on the two side edges of the top cover 100, which facilitates the stable and reliable support of the top cover 100 by the first side cover 210 and the second side cover 220, ensures the strength of support for the top cover 100, and enhances the load-bearing capacity of the top cover 100. The third side cover 230 and the fourth side cover 240 are one-to-one correspondingly mounted on the other two side edges of the top cover 100. The third side cover 230 is connected and mounted to the freight container of the pickup truck, which is of low operational difficulty. The fourth side cover 240 can be fitted with a switch for the truck cover of the freight container to provide a switch window, thus allowing for better use of the trunk cover 1000 provided by the present disclosure.

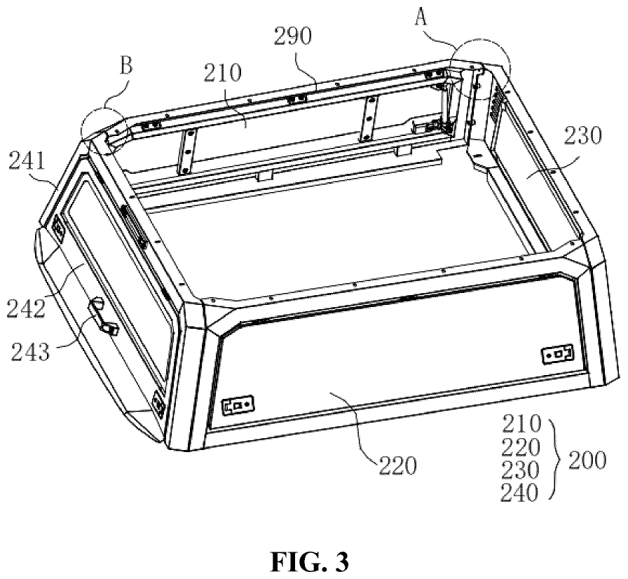

As shown in FIGS. 1 and 3, the trunk cover 1000 includes a first direction M and a second direction N that are perpendicular to each other. Exemplarily, the first direction M can be parallel to the length direction of the trunk cover 1000, and the second direction N can be parallel to the width direction of the trunk cover 1000. In the first direction M, a dimension of the end of the first side cover 210 near the top cover 100 and a dimension of the end of the second side cover 220 near the top cover 100 are both smaller than a dimension of the top cover 100. In the second direction N, a dimension of the end of the third side cover 230 near the top cover 100 and a dimension of the end of the fourth side cover near the top cover 100 are both smaller than a dimension of the top cover 100. This further ensures that the top cover 100 covers the end of the first side cover 210 near the top cover 100, the end of the second side cover 220 near the top cover 100, the end of the third side cover 230 near the top cover 100, and the end of the fourth side cover 240 near the top cover 100. On one hand, this reduces the likelihood of leakage and seepage from the trunk cover 1000; on the other hand, it enhances the load-bearing capacity of the top cover 100.

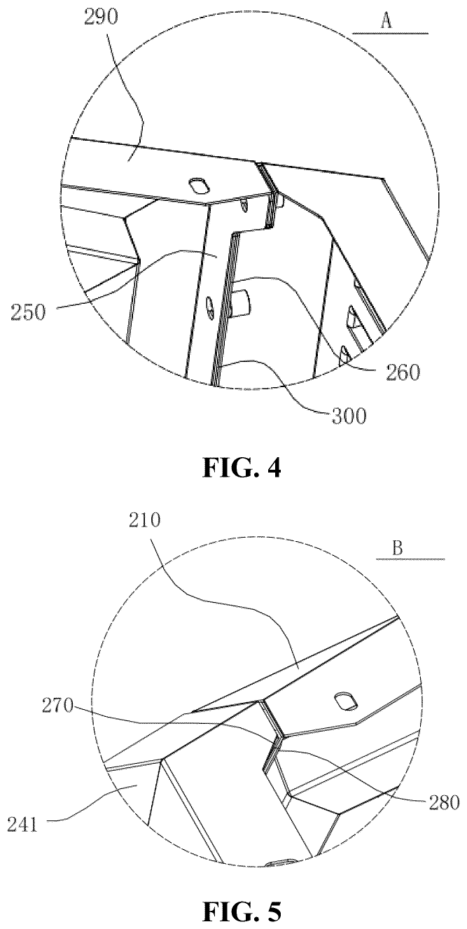

Additionally, as illustrated in FIG. 4, in some embodiments, the end of the first side cover 210 near the third side cover 230 and the end of the second side cover 220 near the third side cover 230 are each provided with a first mounting plate 250. The first mounting plate 250 is arranged at the edges of the first side cover 210 and the second side cover 220, and extends toward the interior of the trunk cover 1000. The first side cover 210 and the second side cover 220 can be detachably connected to the third side cover 230 through the first mounting plate 250.

In the embodiment, both the first side cover 210 and the second side cover 220 are detachably connected to the third side cover 230 via the first mounting plate 250, thus facilitating easy assembly and ensuring reliable mounting of the third side cover 230. The two sides of the third side cover 230 are each detachably connected to the first side cover 210 and the second side cover 220. The top of the third side cover 230 is detachably mounted on the side surface of the top cover 100 near the interior of the trunk cover 1000. The bottom of the third side cover 230 is mounted on the freight container. Furthermore, the detachable connection between the first side cover 210, the second side cover 220, and the third side cover 230 enhances the stability between the side covers 200, thereby increasing the overall reliability and strength of the trunk cover 1000.

Exemplarily, both side edges of the third side cover 230 are provided with second mounting plates 260. The two sides of the third side cover 230 are detachably connected to the first mounting plate 250 on the first side cover 210 and the second side cover 220 via the second mounting plate 260. By providing the first mounting plate 250 and the second mounting plate 260, the third side cover 230 is connected to the first side cover 210 and the second side cover 220, thus improving the convenience of the connections. Moreover, the first mounting plate 250 and the second mounting plate 260 are both arranged inside the trunk cover 1000, which can protect the first mounting plate 250 and the second mounting plate 260 and reduce the likelihood of damage or erosion from prolonged exposure to the first mounting plate 250 and the second mounting plate 260, thereby enhancing the stability of the third side cover 230 in connection with the first side cover 210 and the second side cover 220. Additionally, arranging the connections inside the trunk cover 1000 simplifies the external structure of the trunk cover 1000, thus facilitating the mounting of the trunk cover 1000 on the freight container.

As shown in FIG. 3, in some embodiments, the fourth side cover 240 includes an outer frame 241 and an inner plate 242. The outer frame 241 is in a Π shape, and an end of the outer frame 241 near the top cover 100 can be detachably connected to the top cover 100 via the second connecting plate 290. The inner plate 242 can be hinged inside the outer frame 241. In the embodiment, by providing the outer frame 241 and the inner plate 242, the trunk cover 1000, after mounting onto the freight container of the pickup truck, allows users to conveniently store and retrieve goods inside the freight container through the opening and closing of the inner plate 242, thus facilitating use.

Additionally, in conjunction with FIG. 5, in some embodiments, an end of the outer frame 241 near the first side cover 210 and an end of the outer frame 241 near the second side cover 220 are each provided with a third mounting plate 270. An end of the first side cover 210 near the fourth side cover 240 and the end of the second side cover 220 near the fourth side cover 240 are each provided with a fourth mounting plate 280. The first side cover 210 and the second side cover 220 can be detachably connected to the third mounting plate 270 of the fourth side cover 240 via the fourth mounting plate 280.

In the embodiment, the outer frame 241 is detachably connected to the first side cover 210 and the second side cover 220, thus allowing the side covers 200 of the trunk cover 1000 to connect and form a whole. The arrangement further improves the strength, safety, and reliability of the trunk cover 1000, provides support for the top cover 100, and enhances the load-bearing capacity of the top cover 100. Furthermore, during the production and mounting of the trunk cover 1000, the side covers 200 can be connected first, and then the top cover 100 covers the side covers 200. The mounting method is simple and easy to handle, which reduces the assembly difficulty of the trunk cover 1000.

In some embodiments, the end of the inner plate 242, away from the top cover 100, can be provided with a handle 243, which is located on the side of the inner plate 242 away from the third side cover 230. This allows users to conveniently grip the handle when opening and closing the inner plate 242, thus enhancing the convenience and comfort when using the trunk cover 1000.

In some embodiments, a waterproof glue 300 is provided at the connection between the top cover 100 and the side cover 200 and at the connection between the side covers 200, which can further improve the waterproof effect at the corresponding connection seams.

Moreover, in the trunk cover 1000 provided by the present disclosure, the top cover 100 covers the end of the side cover 200 near the top cover 100. During rain or snow weather, rainwater will fall on the top cover 100 and flow down along the top cover 100, which can reduce the possibility of rainwater flowing into the connection seam between the top cover 100 and the side cover 200. Therefore, it prevents the waterproof glue 300 at the corresponding positions from frequently contacting rainwater, thus reducing the aging speed of the waterproof glue 300 and improving the service life of the waterproof glue 300.

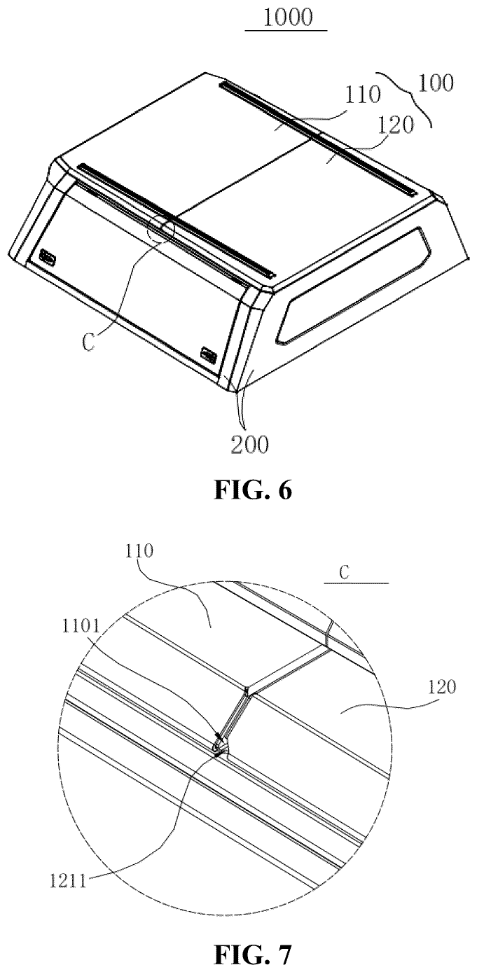

As shown in FIG. 6, in some embodiments, the top cover 100 includes at least two splicing plates, and the at least two splicing plates can be sequentially connected to form a complete top cover 100. Thus, when the trunk cover 1000 is not assembled for use, the top cover 100 can be split into at least two splicing plates, and the at least two splicing plates can be stacked to reduce the occupied space of the top cover 100, thereby facilitating its transportation and storage.

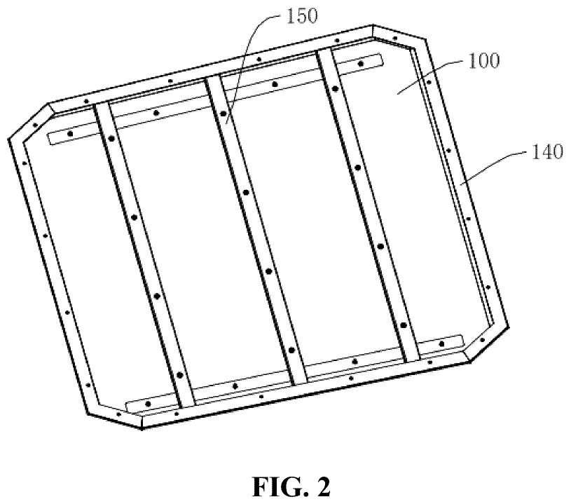

As shown in FIG. 1 and FIG. 2, of course, in other embodiments, the top cover 100 can also be a complete structure.

As shown in FIG. 3 and FIG. 6, the top cover 100 can include a first splicing plate 110 and a second splicing plate 120. The first splicing plate 110 and the second splicing plate 120 can be spliced together to form a complete top cover 100. In some embodiments, the first splicing plate 110 and the second splicing plate 120 can be riveted to each other by rivet bolts to achieve a fixed connection. The first splicing plate 110 can be arranged near one end of the fourth side cover 240.

In other embodiments, the top cover 100 can also include three, four, or six splicing plates. Multiple splicing plates can be sequentially connected to form a complete top cover 100.

In other embodiments, the first splicing plate 110 and the second splicing plate 120 can also be fixedly connected through screws, welding, or snap connections.

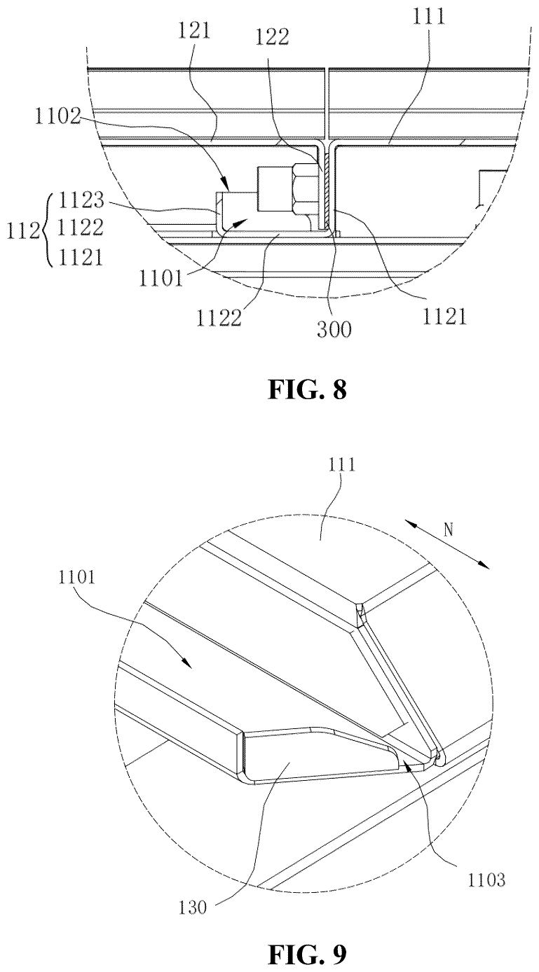

In conjunction with FIG. 7 and FIG. 8, the side of the first splicing plate 110, near the second splicing plate 120, can be configured with a water guide groove 1101. During use, the water guide groove 1101 can be configured to collect rainwater that seeps into the connection seam between the first splicing plate 110 and the second splicing plate 120, thus reducing the probability of rainwater entering the freight container of the pickup truck through the connection seam between the first splicing plate 110 and the second splicing plate 120.

In the embodiment, the water guide groove 1101 is also configured with an opening structure 1102, and the second splicing plate 120 can cover the opening structure 1102, so that the rainwater collected by the water guide groove 1101 mainly comes from the seepage at the connection seam between the first splicing plate 110 and the second splicing plate 120. Therefore, the rainwater is prevented from directly falling into the water guide groove 1101, which could otherwise increase the volume of rainwater in the water guide groove 1101. This reduces the impact on the capacity of the water guide groove 1101 to collect seeped rainwater.

In some embodiments, the first splicing plate 110 can include a first splicing plate main body 111 and a bending portion 112 that are integrally molded. The bending portion 112 can be located at an end of the first splicing plate main body 111 near the second splicing plate 120. The water guide groove 1101 can be formed by bending the bending portion 112.

In some embodiments, the bending portion 112 can include a first bending plate 1121, a second bending plate 1122, and a third bending plate 1123 that are sequentially arranged. The first bending plate 1121 is connected between the first splicing plate main body 111 and the second bending plate 1122 and extends toward a side of the first splicing plate main body 111 near the side cover 200. The second bending plate 1122 can be the groove bottom of the water guide groove 1101 and is opposite to the opening structure 1102. The third bending plate 1123 is opposite and parallel to the first bending plate 1121. Thus, the first bending plate 1121, the second bending plate 1122, and the third bending plate 1123 can cooperate to form a water guide groove 1101 in a U-shaped structure.

In some other embodiments, the bending portion 112 can include the first bending plate 1121 and the third bending plate 1123, wherein the third bending plate 1123 is connected to a side of the first bending plate 1121 that is away from the first splicing plate main body 111, and the first bending plate 1121 and the third bending plate 1123 can cooperate to form a V-shaped water guide groove 1101.

In conjunction with FIG. 1 and FIG. 9, in some embodiments, the water guide groove 1101 can extend along the second direction N and have an extension length that is approximately equal to that of the top cover 100 in the second direction N. Water outlets 1103 are configured at both ends of the water guide groove 1101 in the second direction N, and the water outlet 1103 can communicate with the external environment to discharge rainwater from the water guide groove 1101.

In some other embodiments, a water outlet 1103 can also be arranged at one end of the water guide groove 1101 to discharge rainwater from the water guide groove 1101.

The position of the water outlet 1103 on the water guide groove 1101 is also configured with a flow guide plate 130. In some embodiments, one end of the flow guide plate 130 can be connected to the third bending plate 1123, and the other end of the flow guide plate 130 can extend toward the direction close to the first bending plate 1121, thus allowing the water outlet 1103 to be gathered between the flow guide plate 130 and the first bending plate 1121.

Additionally, the flow guide plate 130 is gradually inclined in a direction away from the flow guide plate 130 at the other end from the end near the third bending plate 1123 to the end near the first bending plate 1121. The flow guide plate 130 can direct the flow of water in the water guide groove 1101, thus allowing the water to converge towards the position of the water outlet 1103 for discharge.

As shown in FIG. 7 and FIG. 8, in some embodiments, the second splicing plate 120 can include a second splicing plate main body 121 and a transition plate 122 that are integrally molded. The transition plate 122 can be located at one end of the second splicing plate main body 121 near the first splicing plate 110, and protrudes relative to the side of the second splicing plate main body 121 near the side cover 200. In the embodiment, the second splicing plate main body 121 and the first splicing plate main body 111 are generally located in the same plane.

The transition plate 122 can fit against a side of the first bending plate 1121 near the third bending plate 1123. The transition plate 122 and the first bending plate 1121 can be fixedly connected by riveting with rivet bolts, screw connections, or snap connections, thereby achieving a fixed connection between the first splicing plate 110 and the second splicing plate 120. It can be understood that the connection seam between the first splicing plate 110 and the second splicing plate 120 can refer to the gap between the transition plate 122 and the first bending plate 1121.

In some embodiments, the waterproof glue 300 is also arranged between the transition plate 122 and the first bending plate 1121, which can further reduce the leakage of rainwater at the connection seam between the transition plate 122 and the first bending plate 1121. In other words, it reduces the possibility of rainwater seeping through the connection seam between the first splicing plate 110 and the second splicing plate 120, thereby decreasing the risk of rainwater leakage from the trunk cover 1000.

The end of the second splicing plate main body 121, close to the transition plate 122, is also configured with two avoidance notches 1211, the two avoidance notches 1211 can be separately arranged at both ends of the second splicing plate main body 121 in the second direction N. In the embodiment, the two avoidance notches 1211 are one-to-one correspondingly arranged with the two water outlets 1103, and the water outlets 1103 can be exposed through the corresponding avoidance notches 1211 and communicate with the external environment to discharge rainwater from the water guide groove 1101.

In some other embodiments, the water guide groove 1101 can also be a recessed groove structure arranged on the first splicing plate 110, which is located at one end of the first splicing plate 110 near the second splicing plate 120. The end of the first splicing plate 110, where the water guide groove 1101 is arranged, can extend toward the side of the second splicing plate 120 near the side cover 200 by providing a step structure so that the second splicing plate 120 can cover the opening structure 1102 of the water guide groove 1101.

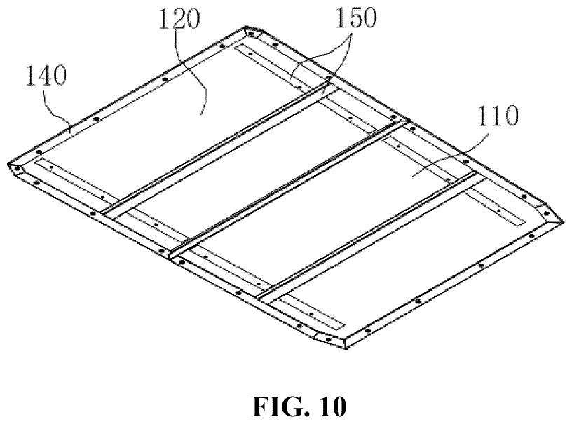

As shown in FIG. 1, FIG. 2, and FIG. 10, in some embodiments, the side surface of the top cover 100 facing the side cover 200 is provided with multiple reinforcement ribs 150, wherein the multiple reinforcement ribs 150 can be arranged in a grid-like distribution, and the end portions of some reinforcement ribs 150 can connect to the first connecting plate 140. Thus, the strength of the top cover 100 itself is enhanced, further improving the load-bearing capacity of the top cover 100. This reduces the probability of denting the top cover 100 under load, meaning reducing the probability of the top cover 100 deforming. Thus, the impact on the overall strength of the trunk cover 1000 is reduced.

In the embodiment, a pickup truck is also provided, which includes a cab, an open freight container, and the trunk cover 1000 provided in the above embodiments, wherein the trunk cover 1000 is mounted on the open freight container.

In the description of the specification, references to terms such as “some embodiments”, “example”, “specific example”, or “some examples” mean that specific features, structures, materials, or characteristics described in connection with the embodiment or example are included in at least one embodiment or example of the present disclosure. In the summary, illustrative expressions of the above terms do not necessarily have to refer to the same embodiments or examples. Moreover, specific features, structures, materials, or characteristics described can be appropriately combined in any one or more embodiments or examples.

Additionally, in a non-conflicting manner, those skilled in the art may combine and modify different embodiments or examples and the features of the different embodiments or examples as described in the description.

Although exemplary embodiments of the present disclosure have been shown and described above, it should be understood that these embodiments are illustrative and should not be construed as limiting the scope of the present disclosure. Those skilled in the art can make variations, modifications, substitutions, and alterations to the above embodiments within the scope of the present disclosure.

1. A trunk cover, comprising
a top cover, wherein an edge of a side surface of the top cover is provided with a first connecting plate; and
multiple side covers, arranged around an edge of the top cover for a circumference, wherein each side cover is provided with a second connecting plate at an end close to the top cover, the second connecting plate is arranged parallel to the first connecting plate, the second connecting plate is detachably connected to the first connecting plate, the multiple side covers are all arranged obliquely relative to the top cover, and the top cover covers an end of the side covers near the top cover.

2. The trunk cover according to claim 1, wherein the multiple side covers comprise a first side cover, a second side cover, a third side cover, and a fourth side cover, the first side cover and the second side cover are one-to-one correspondingly connected to two opposite side edges of the top cover, and the third side cover and the fourth side cover are one-to-one correspondingly mounted on other two opposite side edges of the top cover.

3. The trunk cover according to claim 2, wherein the trunk cover is configured with a first direction and a second direction that are perpendicular to each other;
in the first direction, a dimension of an end of the first side cover near the top cover and a dimension of an end of the second side cover near the top cover are both smaller than a dimension of the top cover; and
in the second direction, a dimension of an end of the third side cover near the top cover and a dimension of an end of the fourth side cover near the top cover are both smaller than a dimension of the top cover.

4. The trunk cover according to claim 2, wherein an end of the first side cover near the third side cover and an end of the second side cover near the third side cover are each provided with a first mounting plate, the first mounting plate is arranged at an edge of the side cover where the first mounting plate is located and faces an interior of the trunk cover, and both the first side cover and the second side cover are detachably connected to the third side cover through the first mounting plate.

5. The trunk cover according to claim 4, wherein both side edges of the third side cover are provided with second mounting plates, and the third side cover is detachably connected to the first mounting plate on the first side cover and the first mounting plate on the second side cover through the two second mounting plates in a one-to-one correspondence.

6. The trunk cover according to claim 2, wherein the fourth side cover comprises an outer frame and an inner plate, the outer frame is in a Π shape, the outer frame is detachably mounted to the top cover through the second connecting plate, and the inner plate is hinged inside the outer frame.

7. The trunk cover according to claim 6, wherein an end of the outer frame near the first side cover and an end of the outer frame near the second side cover are each provided with a third mounting plate, an end of the first side cover near the outer frame and an end of the second side cover near the outer frame are each provided with a fourth mounting plate, and both the first side cover and the second side cover are detachably connected to the third mounting plate of the fourth side cover via the fourth mounting plate.

8. The trunk cover according to claim 1, wherein the top cover comprises at least two splicing plates, and the at least two splicing plates are sequentially connected.

9. The trunk cover according to claim 8, wherein the top cover comprises a first splicing plate and a second splicing plate that are connected; and
an end of the first splicing plate near the second splicing plate is provided with a water guide groove, the water guide groove is provided with an opening structure, and the second splicing plate covers the opening structure.

10. The trunk cover according to claim 9, wherein the first splicing plate comprises a first splicing plate main body and a bending portion, the bending portion is located at an end of the first splicing plate main body near the second splicing plate, and the water guide groove is formed by the bending portion.

11. The trunk cover according to claim 10, wherein the bending portion comprises a first bending plate, a second bending plate, and a third bending plate; the first bending plate is connected between the first splicing plate main body and the second bending plate; the third bending plate is opposite to the first bending plate; and the opening structure is opposite to the second bending plate; and
the first bending plate, the second bending plate, and the third bending plate cooperate to form the water guide groove.

12. The trunk cover according to claim 10, wherein the bending portion comprises a first bending plate connected to the first splicing plate main body;
the second splicing plate comprises a second splicing plate main body and a transition plate, wherein the transition plate is located on a side of the second splicing plate main body near the first splicing plate; and
the transition plate is fitted against a side of the first bending plate near the second splicing plate and is connected to the first bending plate.

13. The trunk cover according to claim 9, wherein the trunk cover is configured with a second direction, and the water guide groove is parallel to the second direction; and
along the second direction, at least one end of the water guide groove is configured with a water outlet that communicates with an external environment.

14. The trunk cover according to claim 13, wherein along the second direction, each end of the water guide groove is configured with the water outlet; and
a side of the second splicing plate near the first splicing plate is configured with two avoidance notches, and each of two water outlets correspondingly communicates with the external environment through one of the two avoidance notches.

15. The trunk cover according to claim 13, wherein a position where the water outlet is located is further configured with a flow guide plate, and the flow guide plate is configured to direct water in the water guide groove towards the water outlet for collection.

16. The trunk cover according to claim 1, wherein a side surface of the top cover facing the side cover is provided with multiple reinforcement ribs, the multiple reinforcement ribs are arranged in a grid-like distribution, and an end portion of each reinforcement rib is connected to the first connecting plate.

17. A pickup truck, comprising a cab, an open freight container, and the trunk cover according to claim 1, wherein the trunk cover is mounted on the open freight container.

18. The trunk cover according to claim 3, wherein an end of the first side cover near the third side cover and an end of the second side cover near the third side cover are each provided with a first mounting plate, the first mounting plate is arranged at an edge of the side cover where the first mounting plate is located and faces an interior of the trunk cover, and both the first side cover and the second side cover are detachably connected to the third side cover through the first mounting plate.

19. The trunk cover according to claim 3, wherein the fourth side cover comprises an outer frame and an inner plate, the outer frame is in a Π shape, the outer frame is detachably mounted to the top cover through the second connecting plate, and the inner plate is hinged inside the outer frame.

20. The trunk cover according to claim 11, wherein the bending portion comprises a first bending plate connected to the first splicing plate main body;
the second splicing plate comprises a second splicing plate main body and a transition plate, wherein the transition plate is located on a side of the second splicing plate main body near the first splicing plate; and
the transition plate is fitted against a side of the first bending plate near the second splicing plate and is connected to the first bending plate.
